(19) United States
(12) Patent Application Publication
(10) Pub. No.: US 2004/0071961 A1
(43) Pub. Date: Apr. 15, 2004

(54) Sealant bead

(76) Inventor: Olivier Jevons, Macclesfield Cheshire (GB)

Correspondence Address: Timothy A Cassidy, Dority & Manning, PO Box 1449, Greenville, SC, 29602-1449, US

(21) Appl. No.: 10/333,559

(22) PCT Filed: Jul. 20, 2001
(86) PCT No.: PCT/GB01/03268

(30) Foreign Application Priority Data
Jul. 26, 2000 (GB) 0018174.3

(51) Int. Cl. C09J 7/02

(52) U.S. Cl. 428/343

(57) ABSTRACT

A sealant bead for application to a join between panel members such as the skin of an automobile door and the internal panelling of the door, the bead comprising an extrusion of curable, and hence readily extendable, material, and incorporating an inextensible filament.

This application relates to sealant beads for application to a join between panel members such as the skin of an automobile door and the internal panelling of the door.

When a vehicle is manufactured, these joins are all caulked by a sealant ejected from a dispenser which is, nowadays, wielded by a robot. This ensures perfectly even application all round, for example, the rim of a door. Sealant is, however, applied also along joins between a boot (trunk) or bonnet (hood) panel and its internal bracing ribs.

When a car is repaired, no robot is to hand in a body shop, and sealant has to be applied manually. To produce a neat finish like that of the robot, a preformed bead is used. The bead is supplied on a reel in widths of 8 mm and 10 mm, and has an adhesive face covered with a release layer. A desired length of bead is unreeled, the release lining removed, and the bead applied manually along the join, which is first cleaned and primed.

As the bead is required to negotiate bends without any wrinkling, it is made with a degree of conformability. After application, it is curable as by heat or moisture to harden it before it is painted as part of the panel. The conformability, however, means that it is readily stretchable, and the manufacturers enjoin the user against stretching the bead, which would result in thick and thin places, detracting from the ‘professional’ (i.e. robot-perfect) appearance of the finished product. As a result, a degree of care has to be exercised which adds to the time required to apply the bead and results in costlier repairs.

The present application provides an improved bead that does not suffer this disadvantage and which can also provide other advantages.

The invention comprises a sealant bead for application to a join between panel members such as the skin of an automobile door and the internal panelling of the door, the bead comprising an extrusion of curable, and hence readily extendable, material, and incorporating an inextensible filament.

The bead may have a plurality—say, two or three—of inextensible filaments.

By “inextensible” is meant, of course, inextensible by comparison with the conformable bead material. The bead may comprise an extrusion of polyurethane, polyvinyl chloride or an MS polymer, which may extend inelastically, or with not very much elastic recovery, by up to 20% on relatively small tensile forces, such as might be experienced when pulling off a roll or being applied to a join.

The incorporated filament may comprise a polyamide or a polyester filament, such as may be used as a fishing line for example.

The bead may be adapted for heat curing, and the incorporated filament should then be able to withstand curing heat without shrinkage—in practice, this will mean that a drawn filament has been heat set under more severe temperature conditions than will be experienced during curing of the bead.

The bead may be adapted for moisture curing, however, which may take place simply upon exposure to atmosphere after removal from its packaging and application to a join.

The bead may be profiled on one face and have a flat, adhesive-coated face for application to the join. Preferably, the adhesive system is primeness, and will adhere well to metal surfaces which have been merely cleaned in the usual way using a degreasing solvent.

As in the prior art product, the bead may have a release liner against an adhesive face. The release liner may be wider than the bead, for ease of removal.

However, the bead of the-invention may dispense with the release liner if the adhesive coated face which, on a spool, is against an uncoated face, has the adhesive adhering preferentially to the adhesive coated face, facilitating peel-off without contamination of the uncoated face.

The coated and/or the uncoated face may be recessed or profiled (while, in the case of the coated face, being generally flat, or at least only shallowly recessed or profiled so that the adhesive may readily be pressed and adhered against the join).

Embodiments of sealant bead according to the invention will now be described with reference to the accompanying drawings, in which:

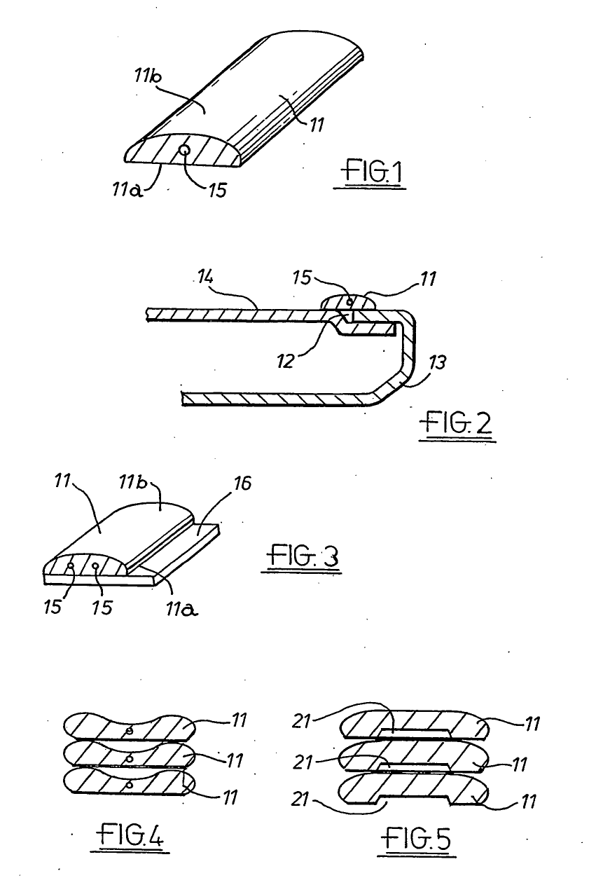

FIG. 1 is an end-on view of a length of a first embodiment of a bead;

FIG. 2 is a section through an automobile door rim showing the bead in situ

FIG. 3 is a view like FIG. 1 of a second embodiment of bead;

FIG. 4 is a section through three layers of a third embodiment of bead on a reel; and

FIG. 5 is a section like FIG. 4 of a fourth embodiment of bead.

The drawings illustrate a sealant bead 11 for application to a join 12 (FIG. 2) between panel members such as the skin 13 of an automobile door and the internal panelling 14 of the door, the bead 11 comprising an extrusion of curable, and hence readily extendable material and incorporating an inextensible filament 15.

FIG. 2 illustrates a sealant bead 11 incorporating two inextensible filaments 15.

The bead 11 comprises an extrusion of polyurethane, poly vinyl chloride, while the filament 15 comprises a poylamide or polyester filament.

The bead 11 would be supplied normally on a reel (containing, say, 10 metres) and, on withdrawal from the reel, applied to the join after cleaning the join area with degreasing solvent. For adhesive to the join area, the bead 11 has a flat face 11a coated with adhesive, preferably one that can be applied directly to the metal surfaces of an automobile without the need for a previous application of a primer.

The other face 11b of the bead 11 is profiled so as to resemble the robot-applied caulking bead of the motor manufacturer.

The bead 11, once applied, is cured, either by heat or by moisture. If heat curing is specified, at a given temperature, the inextensible filament should not, at that temperature, be subject to heat shrinkage, which means that it will have been heat set after drawing at a dry temperature or an equivalent steam setting temperature in excess of the heat-curing temperature.

To protect the adhesive on face 11a a release liner 16 (FIG. 3) can be used in the usual way; however, it is preferred that the liner 16 be wider than the bead, as shown, to facilitate separation.

FIG. 4 illustrates an arrangement which dispenses with a release liner, the beads 11 being profiled so that only a small area of adhesive on the flat underface 11a is in contact with the profiled face 11b, so that the force required to remove the tape layer from layer is small.

If at some time, the profiled face 11b can be treated to have a lower affinity for the adhesive than the underface 11a, the bead 11 may be safely stacked on a reel.

FIG. 5 illustrates another component in which the underface 11a has a shallow recess 21, keeping its adhesive away from the opposite face. The recess 21 is sufficiently shallow that it is easily depressed on to the join.

1. A sealant bead for application to a join between panel members such as the skin of an automobile door and the internal panelling of the door, the bead comprising an extrusion of curable, and hence readily extendable, material, and incorporating an inextensible filament.

2. A bead according to claim 1, having a plurality of inextensible filaments.

3. A bead according to claim 1 or claim 2, comprising an extrusion of polyurethane.

4. A bead according to claim 1 or claim 2, comprising an extrusion of poly vinyl chloride.

5. A bead according to claim 1 or claim 2, comprising an extrusion of MS polymer.

6. A bead according to any one of claims 1 to 5, in which the incorporated filament comprises a polyamide filament.

7. A bead according to any one of claims 1 to 6, in which the incorporated filament comprises a polyester filament.

8. A bead according to any one of claims 1 to 7, adapted for heat curing.

9. A bead according to claim 8, in which the incorporated filament can withstand curing without shrinkage.

10. A bead according to any one of claims 1 to 7, adapted for moisture curing.

11. A bead according to any one of claims 1 to 10, having a flat, adhesivecoated face.

12. A bead according to claim 11, having a primeness adhesive system.

13. A bead according to any one of claims 1 to 12, having a release liner against an adhesive coated face.

14. A bead according to claim 13, of which the release liner is wider than the bead whereby to facilitate removal.

15. A bead according to any one of claims 1 to 12, having an adhesive coated face which on a spool is against an uncoated face the adhesive adhering preferentially to the adhesive coated face facilitating peel-off without contamination by the uncoated face.

16. A bead according to claim 15, of which the coated face is recessed or profiled to reduce the surface area in contact on the spool but the bead is sufficiently flexible to place all the adhesive coated area in internal contact with the join to which it is to be applied.
